(19) United States
(12) Patent Application Publication
(10) Pub. No.: US 2025/0348302 A1
(43) Pub. Date: Nov. 13, 2025

(54) FIRMWARE UPGRADE DURATION ESTIMATION FOR TELECOMMUNICATIONS DEPLOYMENTS

(71) Applicant: Dell Products L.P., Round Rock, TX (US)

(72) Inventors: Ramesh Ganapathi, Chennai (IN); Vinay Sawal, Fremont, CA (US); Mihai Lazar, Nepean (CA)

(21) Appl. No.: 18/660,875

(22) Filed: May 10, 2024

(51) Int. Cl. G06F 8/65

(52) U.S. Cl. CPC G06F 8/65

(57) ABSTRACT

A method facilitating firmware upgrade duration estimation for telecommunications deployments includes constructing, by a first system including at least one processor, a graph structure representative of a firmware upgrade to be performed on a second system, the graph structure including nodes representative of upgrade operations associated with the firmware upgrade and edges connecting respective pairs of the nodes, the edges being representative of dependencies between respective ones of the upgrade operations corresponding to the pairs of the nodes; estimating, by the first system, respective first time durations of the upgrade operations, resulting in estimated operation durations; and generating, by the first system and as a function of the estimated operation durations and based on a selected path formed by the nodes and the edges of the graph structure, an estimated second time duration for execution of the firmware upgrade on the second system.

### BACKGROUND

Current telecommunications system deployments, such as those utilizing Fifth Generation (5G) wireless standards, can make extensive use of computing servers for executing containerized workloads. For instance, a gNodeB (gNB), which serves as a base station in 5G, can use multiple servers and/or server clusters to realize centralized unit (CU) and/or distributed unit (DU) functionality. Other elements of a wireless communication network, such as at the core network and/or radio access network levels, can also use servers and/or server clusters to implement their respective functionality. A typical telecommunications deployment can include thousands of servers, deployed at various locations (e.g., data centers, cell sites, etc.), and these locations can be interconnected through network links of various characteristics (throughput, latency, reliability, etc.).

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include constructing a graph structure representative of a firmware upgrade to be applied to a computing system. The graph structure can include nodes representative of tasks associated with the firmware upgrade and edges connecting respective pairs of the nodes, the edges being representative of dependencies between respective ones of the tasks corresponding to the pairs of the nodes. The operations can further include generating task time data representative of respective first estimated time durations of the tasks. The operations can also include generating, as a function of the task time data and based on a selected path formed by the nodes and the edges of the graph structure, a second estimated time duration associated with applying the firmware upgrade to the computing system.

In another implementation, a method is described herein. The method can include constructing, by a first system including at least one processor, a graph structure representative of a firmware upgrade to be performed on a second system. The graph structure can include nodes representative of upgrade operations associated with the firmware upgrade and edges connecting respective pairs of the nodes, the edges being representative of dependencies between respective ones of the upgrade operations corresponding to the pairs of the nodes. The method can additionally include estimating, by the first system, respective first time durations of the upgrade operations, resulting in estimated operation durations. The method can further include generating, by the first system and as a function of the estimated operation durations and based on a selected path formed by the nodes and the edges of the graph structure, an estimated second time duration for execution of the firmware upgrade on the second system.

In an additional implementation, a non-transitory machine-readable medium is described herein that can include instructions that, when executed by at least one processor, facilitate performance of operations. The operations can include constructing a graph structure representative of a firmware upgrade to be applied to a telecommunication system, the graph structure including nodes representative of tasks associated with the firmware upgrade and edges connecting respective pairs of the nodes, the edges being representative of dependencies between respective ones of the tasks corresponding to the pairs of the nodes; generating task duration data representative of estimated first time durations of the tasks; and generating, as a function of the task duration data and based on a selected path through the graph structure, an estimated second time duration of applying the firmware upgrade to the telecommunication system.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates firmware upgrade duration estimation for telecommunications deployments in accordance with various implementations described herein.

FIG. 2 is a diagram of an example system framework facilitating firmware upgrade duration estimation for telecommunications deployments in accordance with various implementations described herein.

FIG. 3 is a diagram of an example data structure that can be generated in accordance with various implementations described herein.

FIG. 4 is a block diagram of another system that facilitates firmware upgrade duration estimation for telecommunications deployments in accordance with various implementations described herein.

FIGS. 5-7 are diagrams of example data structures that can be generated in accordance with various implementations described herein.

FIGS. 8-9 are block diagrams of additional systems that facilitate firmware upgrade duration estimation for telecommunications deployments in accordance with various implementations described herein.

FIGS. 10-11 are flow diagrams of methods that facilitate firmware upgrade duration estimation for telecommunications deployments in accordance with various implementations described herein.

FIG. 12 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

As noted above, current telecommunications system deployments can make extensive use of computing servers for data processing. For instance, new Fifth Generation (5G) standards deployments, both for the 5G core network and radio access network (RAN), can make use of off-the-shell computing servers for executing 5G workloads, e.g., in Kubernetes clusters. As additionally noted above, a typical telecommunications deployment can include thousands of interconnected servers. These servers can be characterized by their hardware attributes (e.g., compute power/central processing unit (CPU) specifications, memory size, storage size, network bandwidth, etc.) and the software executed by the servers. This software can include, e.g., basic input/output system (BIOS), device drivers and/or firmware for storage, network interface cards, or other devices, a runtime platform (e.g., including an operating system (OS), Kubernetes, etc.), 5G software applications and/or other applications, or other suitable software components.

As communication service providers (CSPs) move from legacy telecommunications solutions to modern cloud-native, open, disaggregated solution architectures such as those described above, it is desirable to provide options that preserve choice, yet offer a reliable, total cost of ownership (TCO)-efficient foundation to build upon. While 5G poses a great opportunity for CSPs to offer new services and applications, it also brings new challenges due to its scale. One of the primary challenges in this area involves lifecycle management of the firmware(s) of the servers in a given deployment. Maintaining up-to-date firmware, e.g., with all security patches along with the latest features in production, can present significant challenges to CSPs.

For instance, when deploying new software or upgrading software associated with a telecommunications deployment, a CSP generally uses a continuous integration/continuous delivery (CI/CD) pipeline to perform the initial deployment, testing, and upgrades of the production environment. During these processes, it is desirable to maintain a minimum level of service associated with the underlying communication network, e.g., such that service level agreement (SLA) parameters are not affected. However, in many cases, a telecommunication deployment involves a heterogeneous set of servers with different hardware and software characteristics, in which software and/or firmware components can be provided by many different vendors. Additionally, application software vendors can perform their own validation on a given software lineup.

For the above and/or other reasons, it can be difficult in most cases to determine the overall duration of a firmware upgrade for a given type of server. As a result, it can be prohibitively difficult for CSPs to plan a maintenance window for firmware upgrades without impacting SLAs. The current mode of slow, labor-intensive lifecycle management in a distributed scaled environment can negatively impact the advantages in cost, agility, and scalability that modern telecommunications technologies can provide.

As an example of the challenges associated with telecommunication server maintenance, information technology (IT) staff and/or other system administrators associated with a CSP generally consider some or all of the following in order to plan for the firmware update procedure of individual servers:
1) Selection of firmware based on priority, e.g., security vulnerabilities vs. latest features.
2) Firmware compatibility with network application workloads.
3) Firmware recommendations of workload vendors, server vendors, and/or other entities for performance and/or scalability improvements.
4) Production server compatibility with the latest firmware.
5) Firmware version compatibility across different firmware versions. For example, a given BIOS version may be compatible with one version of another firmware component but not another version of the same firmware component.
6) Firmware upgrade path, e.g., in multiple steps from an old version to an intermediate version to a most recent version. In some cases, a server reboot can be required after one or more of these steps.

The above and/or other factors can each impact the total duration of the upgrade process.

Implementations as described herein can improve and simplify the firmware upgrade process for a telecommunications deployment by providing accurate estimates of the amount of time associated with performance of a given firmware upgrade path. For example, implementations provided herein can utilize a graph-based approach to facilitate timing analysis for respective steps of a firmware upgrade, based on which the upgrade can be planned and implemented with improved efficiency. By implementing timing analysis processes as described herein, various advantages can be achieved that can improve the performance of a computing system, such as that associated with a telecommunications deployment. These advantages can include, but are not limited to, the following. The total duration of a firmware upgrade associated with multiple upgrade steps can be reduced, e.g., by facilitating ordering of the steps in such a way as to minimize the total amount of time for the upgrade. Maintenance windows for firmware upgrades can be planned in a deterministic fashion with minimal to no impact on SLAs, e.g., resulting in fewer required maintenance windows and improved overall server performance. Direct and indirect dependency tasks for a given upgrade process can be identified prior to a live maintenance window, thereby reducing the probability of errors occurring during the maintenance window that could prolong the process and/or require additional maintenance windows. Other advantages are also possible.

It is noted that while various examples provided herein relate to 5G deployments, these examples are provided merely for illustrative purposes and are not intended to limit the description or the claimed subject matter to any particular network standard(s) or technology(-ies) unless explicitly stated otherwise. Additionally, while various examples herein relate specifically to upgrading firmware (e.g., BIOS, device drivers, etc.), it is noted that respective implementations herein could also be extended to performing other upgrades, such as upgrades of software (e.g., operating systems, applications, etc.) running on respective computing devices, without departing from the scope of this description.

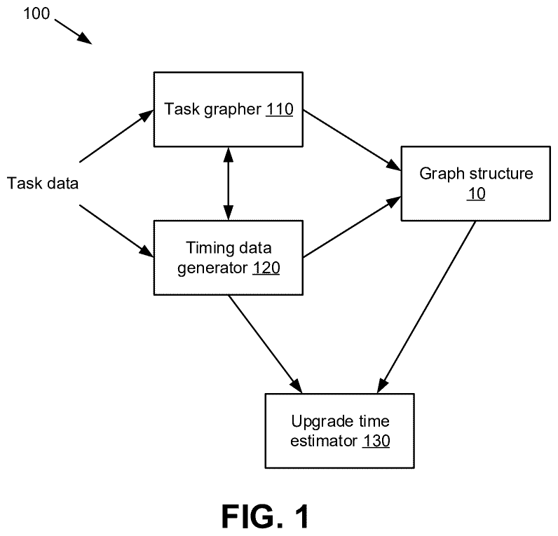

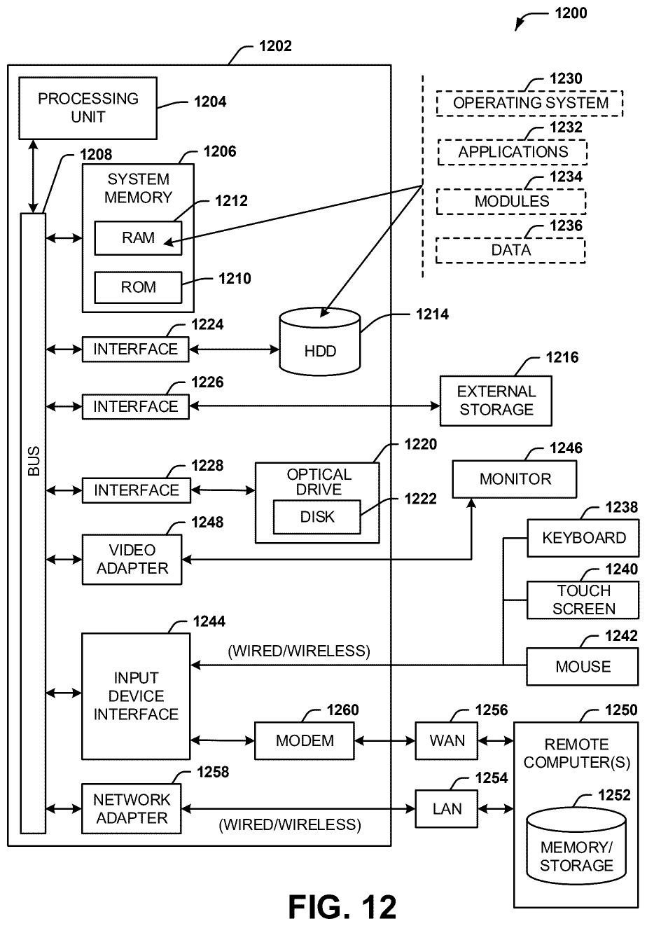

With reference now to the drawings, FIG. 1 illustrates a block diagram of a system 100 that facilitates firmware upgrade duration estimation for telecommunications deployments in accordance with various implementations described herein. System 100 as shown in FIG. 1 includes executable components, e.g., a task grapher 110, a timing data generator 120, and an upgrade time estimator 130, each of which can operate as described in further detail below. In an implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, are shown and described in further detail below with respect to FIG. 12.

Additionally, it is noted that the functionality of the respective components shown and described herein can be implemented via a single computing device and/or a combination of devices. For instance, in various implementations, the task grapher 110 shown in FIG. 1 could be implemented via a first device, the timing data generator 120 could be implemented via the first device or a second device, and the upgrade time estimator 130 could be implemented via the first device, the second device, or a third device. Also, or alternatively, the functionality of a single component could be divided among multiple devices in some implementations.

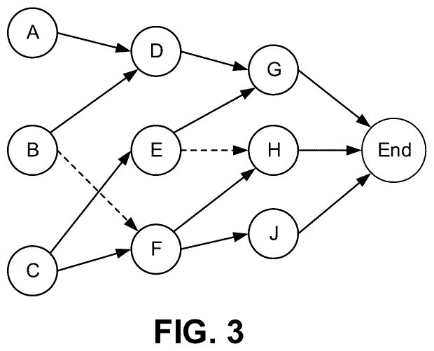

With reference now to the components of system 100, the task grapher 110 can construct a graph structure 10 representative of a firmware upgrade to be applied to a computing system, such as a computing system associated with a telecommunications system deployment and/or another suitable system. The graph structure 10 generated by the task grapher 110 can include nodes representative of tasks associated with the firmware upgrade, as well as edges that connect respective pairs of the nodes and are representative of dependencies between respective ones of the tasks corresponding to the associated node pairs. An example of a graph structure that can be generated by the task grapher 110 is described in further detail below with respect to FIG. 3.

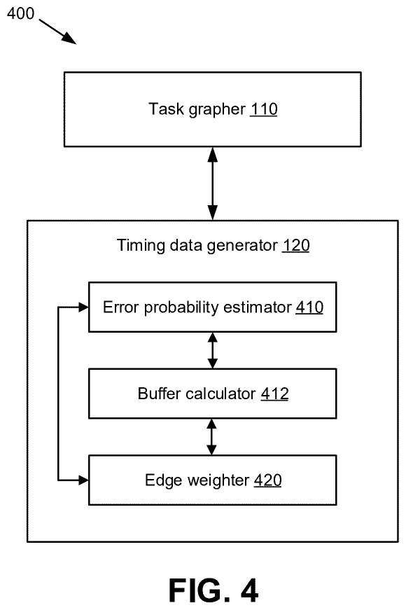

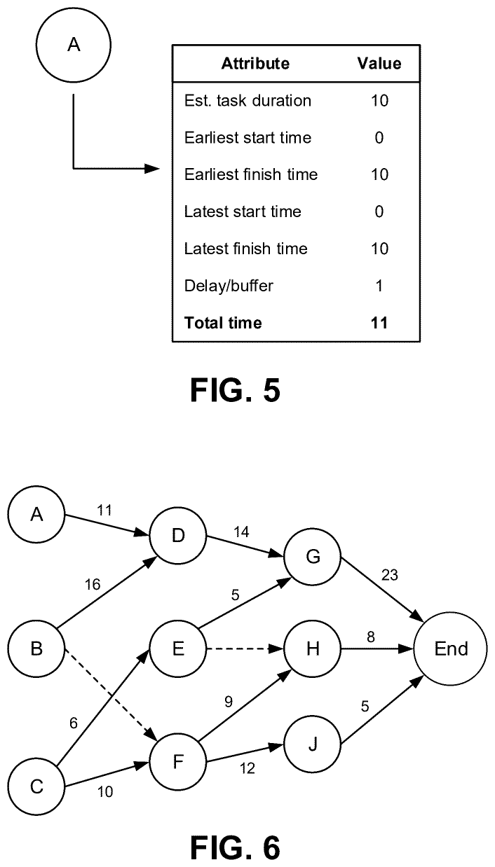

The timing data generator 120 can generate task time data representative of estimated time durations associated with each of the tasks represented in the graph structure 10. An example of time duration data that can be generated by the timing data generator 120 for a given upgrade task is described in further detail below with respect to FIG. 5. Additionally, the timing data generated by the timing data generator 120 can be utilized to weight respective edges of the graph structure 10, as will be described in further detail below with respect to FIGS. 4-6.

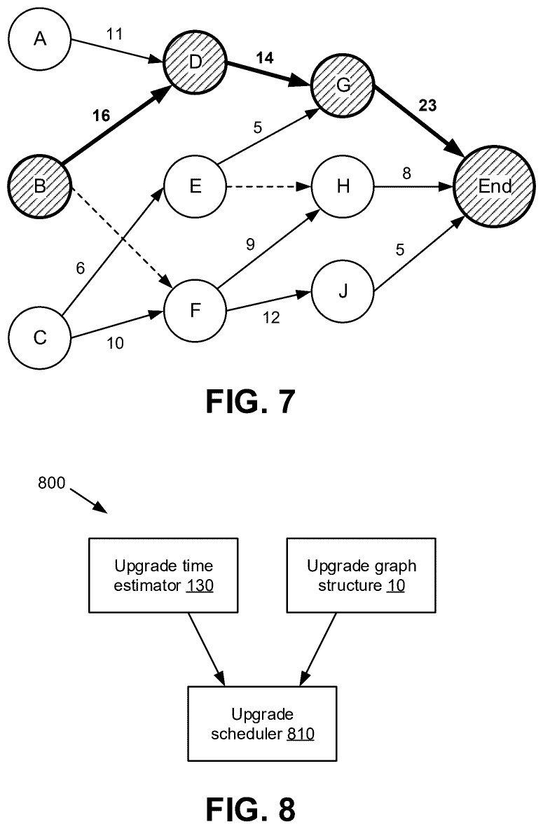

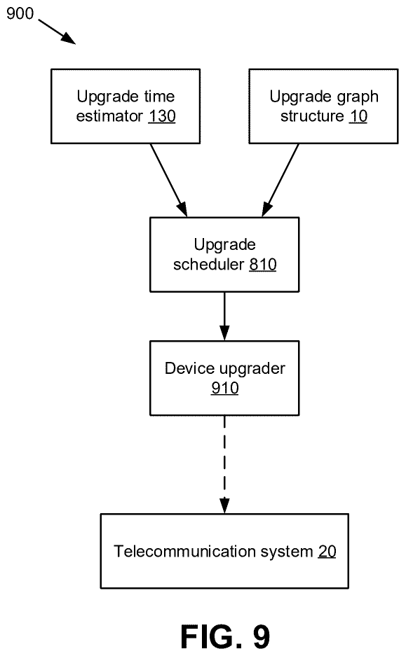

The upgrade time estimator 130 can generate, as a function of the task time data generated by the timing data generator 120 and based on a selected path formed by the nodes and edges of the graph structure 10 as generated by the task grapher 110, an estimated time duration associated with applying the firmware upgrade represented by the graph structure 10 to the computing system. In an implementation, the upgrade time estimator 130 can generate this estimated time duration based on traversing the graph structure 10, e.g., as will be described in further detail with respect to FIG. 7. The estimated time duration generated by the upgrade time estimator 130 can subsequently be utilized to plan and/or carry out a firmware upgrade for a telecommunications system deployment, e.g., as will be further described below with respect to FIGS. 8-9.

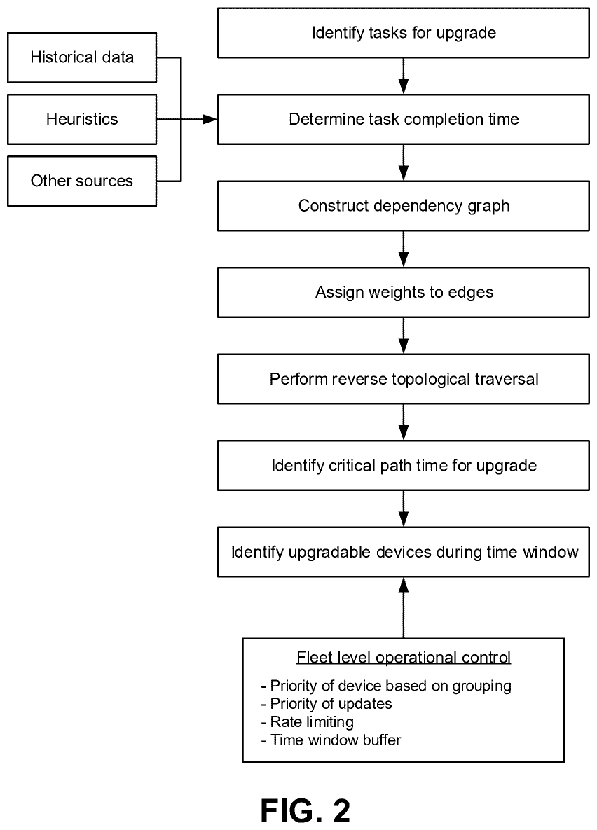

Referring now to FIG. 2, an example system framework facilitating firmware upgrade duration estimation for telecommunications deployments, e.g., that can be utilized by system 100 as shown in FIG. 1, is illustrated. The framework illustrated by FIG. 2 can be utilized to determine the total duration of an upgrade process for individual servers (e.g., in a telecommunications deployment) based on the duration, order, and/or dependencies of respective steps involved in the upgrade.

As shown in FIG. 2, an example workflow for developing a firmware upgrade plan can begin by identifying tasks to be performed during a given upgrade. In an implementation, these tasks can include any task or other activity associated with the upgrade that will take a nonzero amount of time to complete. For example, these tasks can include upgrades to particular firmware elements, such as BIOS, device drivers, or the like. In some cases, an upgrade to a given firmware element could be associated with multiple distinct tasks. By way of example, upgrading a firmware element from a source version X to a target version Y could include multiple intermediate steps, such as a first upgrade of the firmware element from version X to an intermediate version A and then a second upgrade from version A to version Y, each of which could be defined as distinct tasks. In other cases, additional tasks that are performed during the upgrade but do not directly upgrade firmware elements, such as system reboots, could also be identified as tasks during this process. In an implementation with reference to FIG. 1, the task grapher 110 could identify the tasks for a given upgrade based on task data provided to and/or otherwise associated with the task grapher 110.

Following identification of tasks as shown in FIG. 2, the task completion time associated with the identified tasks for the upgrade can be determined. Task completion time can be determined using one or more of the sources shown in FIG. 2, e.g., historical data, heuristics, or other sources. Historical data refers to data relating to time durations a given task has taken previously for equivalent and/or otherwise similar servers to a server to be upgraded. Historical data can be obtained, e.g., from validations performed during lab testing, feedback data received from other servers or systems relating to the same or similar upgrade tasks, etc. Heuristics can include, e.g., duration data obtained via testing run on simulated systems to determine the duration of respective upgrade tasks in different scenarios and/or environments. Other sources can include, as an example, information received from firmware vendors regarding the procedure used to perform a given upgrade task and/or other factors, which can be considered in upgrade time calculations. Still other sources of task duration information could also be considered. In an implementation with reference to FIG. 1, the timing data generator 120 could determine task completion times for respective identified tasks based on one or more of the data types shown in FIG. 2. Additional considerations that can be performed by the timing data generator 120 in this process are described in further detail below with respect to FIG. 4.

As further shown in FIG. 2, after identifying the tasks associated with a firmware upgrade and determining related task duration information, the upgrade can be modeled by constructing a dependency graph, an example of which is shown by FIG. 3. In the example shown by FIG. 3, the dependency graph is a directed acyclic graph (DAG), where each node in the graph corresponds to an identified activity or task of an underlying firmware update with a nonzero duration and each edge in the graph represents a dependent chronological transition, referred to herein as a dependency, from one task to another in a direction denoted by an arrow. The respective nodes of the graph are given arbitrary labels in FIG. 3, here letters A-J, to distinguish between the different tasks for purposes of illustration. Additionally, the graph contains an additional ending node (labeled “End”) corresponding to the completion of the upgrade process. The ending node shown in FIG. 3 may, or may not, be associated with an upgrade task, depending on implementation.

As shown in FIG. 3, a graph structure generated by implementations described herein can include edges representing both “hard” and “soft” dependencies. A “hard” dependency, represented by an unbroken line in FIG. 3, can correspond to a task that must complete before another task may begin. By way of example, if an update for a given firmware element A cannot be started until another, related firmware element B is updated, the update of element B represents a hard dependency for element A. On the other hand, a “soft” dependency, represented by a dashed line in FIG. 3, can correspond to a recommended task order, or a task that exhibits interactions with, and/or provides functionality to, another task but does not prevent the other task from being started prior to its completion. As an example of a soft dependency, a device driver could be updated to include features that are compatible only with an updated version of another firmware component. If the device driver can still function (without the new features) prior to the other firmware component being updated, the firmware component represents a soft dependency for the device driver, as the device driver will not achieve full functionality until the firmware component is updated. In some implementations, hard and soft dependencies can be handled in the same way, e.g., to prevent unexpected behavior in the event that a task completes, but a soft dependency of that task does not.

Referring again to FIG. 2, after constructing a dependency graph for a given upgrade procedure, the edges of the graph structure can be weighted to reflect the task completion time for the respective tasks represented by the graph. An example system 400 for assigning weights to edges of a graph structure is shown by FIG. 4. System 400 as shown in FIG. 4 includes a task grapher 110 and a timing data generator 120, which can populate and apply edge weights to a dependency graph, such as the graph shown in FIG. 3. For instance, the task grapher 110 can populate nodes and/or edges of a graph based on tasks associated with a firmware upgrade and dependencies between those tasks, e.g., as described above. The timing data generator 120 can then generate task time data for respective ones of the tasks, which can then be used to generate graph edge weights.

In various implementations, the timing data generator 120 can generate task time data for a given upgrade task based on various sources of information, such as system configuration data representative of a hardware configuration of a computing system on which the task is to be performed, historical data representative of past time durations for respective upgrade tasks on that system and/or other systems, and/or one or more other sources of data as described above. To further facilitate determining timing data, the timing data generator 120 can include an error probability estimator 410 that can generate error (failure) probability data representative of an estimated failure probability of respective tasks of an upgrade procedure, e.g., based on historical data associated with those tasks, system configuration information relating to a system on which the tasks are to be performed, and/or other data. Based on an estimated error or failure probability as determined by the error probability estimator 410, a buffer calculator 412 of the timing data generator can add a buffer time duration to selected tasks of the upgrade procedure.

In an implementation, the timing data generator 120 can generate timing data for a given upgrade task in a tabular format, an example of which is shown by FIG. 5. More particularly, FIG. 5 illustrates an example of timing data that can be generated for node A in the graph structure shown by FIG. 3. It is noted that other nodes of the graph structure could have similar data, e.g., generated by the timing data generator 120 in a similar manner to that shown by FIG. 5. In the table shown by FIG. 5, the estimated task duration field corresponds to the estimated duration of the corresponding task, e.g., as determined by the timing data generator 120 as described above.

The “earliest start time” and “latest start time” fields shown in FIG. 5 are used to account for soft dependencies, which can result in a range of permissible starting times for a given task. The time figures shown in FIG. 5 are expressed in terms of generic time units, which could be translated to any suitable real time units (e.g., seconds, or fractions of a second such as milliseconds or the like) depending on implementation. The “earliest finish time” and “latest finish time” can then be determined by adding the estimated task duration to the earliest start time and latest start time, respectively, here yielding both an earliest and latest finish time of 10 time units.

The delay/buffer field shown in FIG. 5 can account for additional delays involved in task execution, such as error or failure probabilities as noted above, additional operations not reflected in the graph structure, and/or other delays. Based on these data fields, the timing data generator 120 can then determine the total time associated with transitioning between one node, here node A, to a subsequent node as the sum of the task completion time plus any associated delay time. Accordingly, in the example shown by FIG. 5, the total time duration associated with task A is 10 time units+1 time unit=11 time units.

Returning to FIG. 4, the timing data generator 120 includes an edge weighter 420, which can apply weights to respective edges of the graph structure generated by the task grapher 110 based on the total transition time determined for each node, e.g., as shown in FIG. 5. An example of a weighted graph that can be generated by system 400 is shown by FIG. 6. In the graph shown by FIG. 6, the respective edge weights can be representative of determined transition time intervals associated with transitioning between the tasks connected by the weights, e.g., from node A to node D, from node B to node D, and so on. In a similar manner to the graph shown in FIG. 3, a solid edge represents a hard dependence, which is weighted by the estimated total time associated with moving from one connected node to the other connected node using that particular edge. Alternatively, a dotted edge represents a soft dependency, e.g., where a task is not directly dependent on a previous one but can start only after the previous task has been completed. The “earliest start time” and “latest start time” for each node (e.g., as shown in FIG. 5) can be used to represent the transition times for soft dependencies, i.e., in addition to and/or in place of edge weights.

Returning again to FIG. 2, and with additional reference to FIG. 1, once a dependency graph for a firmware upgrade has been constructed and weighted, the upgrade time estimator 130 can estimate a total time associated with the firmware upgrade by performing reverse topological traversal on the graph structure, e.g., to identify a critical path represented by the graph. For instance, with reference to the weighted graph shown by FIG. 6, the upgrade time estimator 130 can perform a reverse topological sorting algorithm to identify all unique paths for reaching the end node/state of the graph. Here, the unique paths include (1) End→G→D→A/B, (2) End→G→E→C, and (3) End→H→F→C/B.

By using reverse topological sorting, the upgrade time estimator 130 can determine task executions that can happen in parallel, thus saving time and reducing the total duration of the upgrade process to its optimal value. Reverse topological sorting can also facilitate critical path identification, e.g., by identifying the longest path in the graph, representative of the largest amount of time needed to fulfill the dependencies represented by the graph and complete the upgrade. Additionally, by performing reverse topological sorting, i.e., as opposed to forward sorting, the upgrade time estimator 130 can more efficiently determine the potential paths through the graph, since the upgrade represented by the graph structure has only a single end state (i.e., completion of the upgrade) but could have multiple starting states, e.g., corresponding to any tasks in the upgrade with no dependencies.

As described above, the weights on the edges between the nodes of the graph structure can be determined by processing the time attributes of each node, resulting in each edge being assigned a weight that indicates the unit(s) of time it takes to transition from one node connected by the edge to the other. With this information, the upgrade time estimator 130 can traverse the graph in a reverse topological order to determine how long it would take to execute all paths in the graph. Ultimately, this step can enable the upgrade time estimator 130 to identify the longest path, in terms of time units, in the graph, and hence the minimum amount of time required to complete the traversal.

FIG. 7 illustrates a result of executing reverse topological traversal on the graph structure shown in FIG. 6. Here, the critical path identified by the upgrade time estimator 130 is the path from B to D to G to End, which takes 53 time units to complete. Based on this information, the upgrade time estimator 130 can infer that the upgrade process will take at least 53 units to complete. Because the edge weights already factor in buffer time associated with extra operations, potential errors or failures, or the like, the upgrade time estimator 130 can set the predicted time length of the upgrade to the critical path length without adding any additional buffer time after traversal.

Returning once again to FIG. 2, once the critical path time for the upgrade has been determined, the timing information for the upgrade can be applied to an upgrade plan for the underlying computing system, e.g., by identifying upgradable devices during a given time window. Turning to FIG. 8, a system 800 that facilitates generation of an upgrade schedule based on the output of the upgrade time estimator 130 is illustrated. The system 800 includes an upgrade scheduler 810, which can generate a schedule for the firmware upgrade based on a result of comparing the estimated time duration of the upgrade, e.g., as determined by the upgrade time estimator 130 based on the graph structure 10, to the length of a maintenance time window allocated for the firmware upgrade at the target computing system. By way of example, if the upgrade time estimator 130 determines as described above that a given upgrade will take 53 time units, and a maintenance window of 60 units is scheduled at the target computing system, the upgrade scheduler 810 could determine that the upgrade is likely to be successful during the time window and schedule the upgrade for the time window. In addition to a comparison between an estimated upgrade length and a time window length, the upgrade scheduler 810 can also accept one or more control inputs from a fleet level operational control system as shown in FIG. 2, such as device and/or update priorities as specified by the operational control system, any rate limiting associated with the target system, a desired buffer associated with the time window, and/or other factors.

Once the upgrade scheduler 810 has generated a schedule for a firmware upgrade, the upgrade can then be applied to the associated devices of the target system. For instance, as shown by system 900 in FIG. 9, the upgrade scheduler 810 could provide scheduling data to a device upgrader 910, which can perform the firmware upgrade at an associated telecommunication system 20 during a defined maintenance time window according to the schedule. In various implementations, the device upgrader could be implemented in a central system, e.g., with the upgrade time estimator 130 and the upgrade scheduler 810. Also or alternatively, the device upgrader 910 could be associated with the telecommunication system 20 and can be configured to perform the firmware upgrade locally based on input provided from the upgrade scheduler 810.

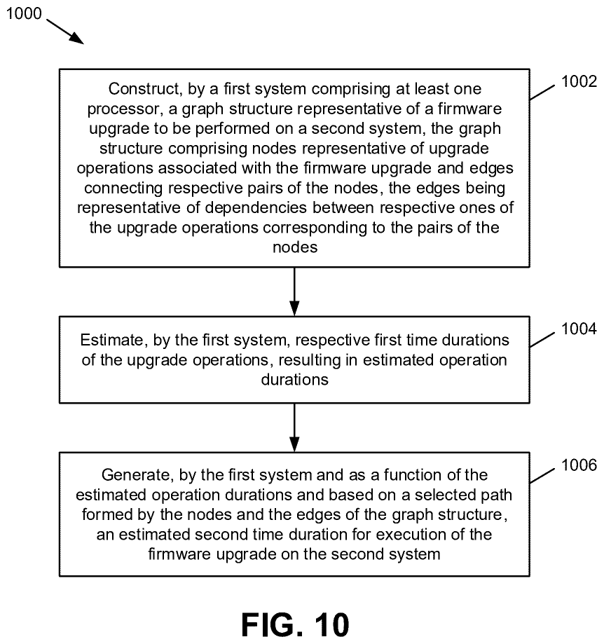

Turning to FIG. 10, a flow diagram of a method 1000 that facilitates firmware upgrade duration estimation for telecommunications deployments is illustrated. At 1002, a first system comprising at least one processor can construct (e.g., by a task grapher 110) a graph structure (e.g., a graph structure 10) representative of a firmware upgrade to be performed on a second system. The graph structure can include nodes representative of upgrade operations associated with the firmware upgrade and edges connecting respective pairs of the nodes. Additionally, the edges can be representative of dependencies between respective ones of the upgrade operations corresponding to the pairs of the nodes.

At 1004, the first system can estimate (e.g., by a timing data generator 120) respective first time durations of the upgrade operations, resulting in estimated operation durations.

At 1006, the first system can generate (e.g., by an upgrade time estimator 130), as a function of the estimated operation durations determined at 1004 and based on a selected path formed by the nodes and the edges of the graph structure constructed at 1002, an estimated second time duration for execution of the firmware upgrade on the second system.

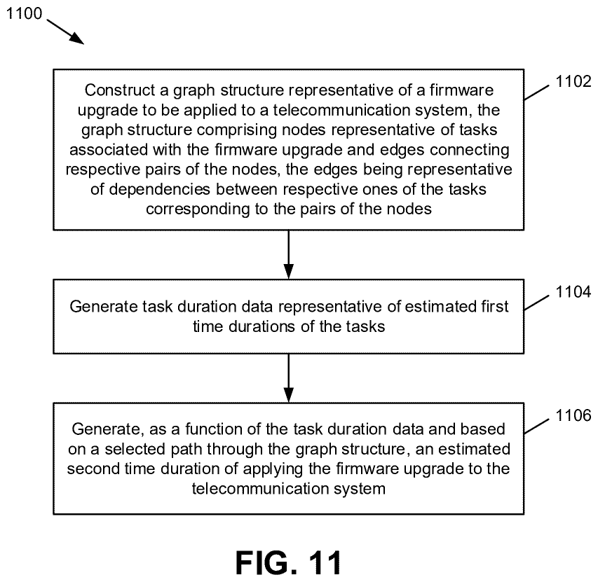

Referring next to FIG. 11, a flow diagram of a method 1100 that can be performed by at least one processor, e.g., based on machine-executable instructions stored on a non-transitory machine-readable medium, is illustrated. Example of computer architectures, including a processor and non-transitory media, that can be utilized to implement method 1000 are described below with respect to FIG. 12.

Method 1100 can begin at 1102, in which the at least one processor can construct a graph structure representative of a firmware upgrade to be applied to a telecommunication system. The graph structure can include nodes representative of tasks associated with the firmware upgrade and edges connecting respective pairs of the nodes. The edges of the graph can be representative of dependencies between respective ones of the tasks corresponding to the pairs of the nodes.

At 1104, the at least one processor can generate task duration data representative of estimated first time durations of the tasks associated with the firmware upgrade.

At 1106, the at least one processor can generate, as a function of the task duration data generated at 1104 and based on a selected path through the graph structure constructed at 1102, an estimated second time duration of applying the firmware upgrade to the telecommunication system.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 12, an example computing environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the. NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
constructing a graph structure representative of a firmware upgrade to be applied to a computing system, the graph structure comprising nodes representative of tasks associated with the firmware upgrade and edges connecting respective pairs of the nodes, the edges being representative of dependencies between respective ones of the tasks corresponding to the pairs of the nodes;
generating task time data representative of respective first estimated time durations of the tasks; and
generating, as a function of the task time data and based on a selected path formed by the nodes and the edges of the graph structure, a second estimated time duration associated with applying the firmware upgrade to the computing system.

2. The system of claim 1, wherein the generating of the task time data is based on system configuration data representative of a hardware configuration of the computing system.

3. The system of claim 1, wherein the computing system is a first computing system, and wherein the generating of the task time data is based on historical data representative of past time durations of the respective ones of the tasks on second computing systems.

4. The system of claim 1, wherein the operations further comprise:
generating error probability data representative of respective estimated probabilities of failure of the tasks at the computing system, wherein the generating of the task time data comprises adding, based on the error probability data, buffer time durations to selected ones of the first estimated time durations.

5. The system of claim 1, wherein the operations further comprise:
generating a schedule for the firmware upgrade based on a result of comparing the second estimated time duration to a length of a maintenance time window allocated for the firmware upgrade at the computing system.

6. The system of claim 5, wherein the operations further comprise:
performing the firmware upgrade at the computing system during the maintenance time window according to the schedule.

7. The system of claim 1, wherein the graph structure is a directed acyclic graph, and wherein the operations further comprise:
applying respective weights to the edges of the graph structure, the respective weights being representative of respective determined transition time intervals associated with transitioning between the respective ones of the tasks corresponding to the pairs of the nodes.

8. The system of claim 7, wherein the generating of the second estimated time duration comprises selecting the selected path of the graph structure by performing a reverse topological traversal of the graph structure.

9. The system of claim 1, wherein the computing system is associated with a telecommunications system deployment.

10. A method, comprising:
constructing, by a first system comprising at least one processor, a graph structure representative of a firmware upgrade to be performed on a second system, the graph structure comprising nodes representative of upgrade operations associated with the firmware upgrade and edges connecting respective pairs of the nodes, the edges being representative of dependencies between respective ones of the upgrade operations corresponding to the pairs of the nodes;
estimating, by the first system, respective first time durations of the upgrade operations, resulting in estimated operation durations; and
generating, by the first system and as a function of the estimated operation durations and based on a selected path formed by the nodes and the edges of the graph structure, an estimated second time duration for execution of the firmware upgrade on the second system.

11. The method of claim 10, wherein the estimating of the estimated operation durations is based on supplemental data of at least one data type selected from a group comprising:
a system configuration type corresponding to system configuration data representative of a hardware configuration of the second system, and
a historical type corresponding to historical data representative of past time durations associated with performance of the upgrade operations on third systems.

12. The method of claim 10, further comprising:
generating, by the first system, failure probability data representative of respective estimated probabilities of failure of the upgrade operations, wherein the estimating of the estimated operation durations comprises adding, based on the failure probability data, time buffer intervals to selected ones of the estimated operation durations.

13. The method of claim 10, further comprising:
generating, by the first system, a schedule for the firmware upgrade based on a result of comparing the estimated second time duration to a length of a maintenance window allocated for the firmware upgrade at the second system.

14. The method of claim 13, further comprising:
performing, by the first system, the firmware upgrade at the second system during the maintenance window according to the schedule.

15. The method of claim 10, wherein:
the graph structure is a directed acyclic graph,
the method further comprises applying, by the first system, respective weights to the edges of the graph structure, the respective weights being representative of determined transition time intervals associated with transitioning between the respective ones of the upgrade operations corresponding to the pairs of the nodes, and
the generating of the estimated second time duration comprises selecting the selected path of the graph structure via a reverse topological traversal of the graph structure.

16. A non-transitory machine-readable medium comprising computer executable instructions that, when executed by at least one processor, facilitate performance of operations, the operations comprising:
constructing a graph structure representative of a firmware upgrade to be applied to a telecommunication system, the graph structure comprising nodes representative of tasks associated with the firmware upgrade and edges connecting respective pairs of the nodes, the edges being representative of dependencies between respective ones of the tasks corresponding to the pairs of the nodes;
generating task duration data representative of estimated first time durations of the tasks; and
generating, as a function of the task duration data and based on a selected path through the graph structure, an estimated second time duration of applying the firmware upgrade to the telecommunication system.

17. The non-transitory machine-readable medium of claim 16, wherein the telecommunication system is a first telecommunication system, and wherein the generating of the task duration data is based on data of at least one data type selected from a group comprising:
a system configuration type corresponding to system configuration data representative of a configuration of the telecommunication system, and
a historical type corresponding to historical data representative of past time durations of the tasks associated with the firmware upgrade on second telecommunication systems.

18. The non-transitory machine-readable medium of claim 16, wherein the operations further comprise:
generating failure probability data representative of respective estimated probabilities of failure of the tasks at the telecommunication system, wherein the generating of the task duration data comprises adding, based on the failure probability data, time buffers to selected ones of the estimated first time durations.

19. The non-transitory machine-readable medium of claim 16, wherein the operations further comprise:
generating a schedule for the firmware upgrade based on a result of comparing the estimated second time duration to a length of a time window allocated for the firmware upgrade at the telecommunication system.

20. The non-transitory machine-readable medium of claim 19, wherein the operations further comprise:
performing the firmware upgrade at the telecommunication system during the time window according to the schedule.
